(19) United States
(12) Patent Application Publication
(10) Pub. No.: US 2007/0064820 A1
(43) Pub. Date: Mar. 22, 2007

(54) Digital broadcasting signal receiver with a plurality of receiving modules

(76) Inventor: Ju-Ting Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/307,881

(22) Filed: Feb. 27, 2006

(30) Foreign Application Priority Data
Sep. 5, 2005 (TW) 094130369

(51) Int. Cl. H04L 27/00

(52) U.S. Cl. 375/259

(57) ABSTRACT

A digital broadcasting signal receiver includes: an antenna module for receiving a digital broadcasting signal; a plurality of receiving modules coupled to the antenna module for processing a plurality of channels of the digital broadcasting signal from the antenna module in parallel; and a transmission interface coupled to the plurality of receiving modules for transmitting signals from the plurality of receiving modules to a corresponding host device.

### BACKGROUND OF THE INVENTION

1. Field of the Invention

The present invention relates to digital broadcasting signal receivers, and more particularly, to digital broadcasting signal receivers capable of processing a plurality of channels of received digital broadcasting signals in parallel.

2. Description of the Prior Art

With the coming of the digital age, conventional analog video and audio broadcasting systems have been gradually transforming into digital broadcasting systems. In conventional analog signal broadcasting systems, reception quality is usually deteriorated by landforms and other environmental factors. On the contrary, digital broadcasting systems can provide signals with better image or audio quality due to their robust communications performance. In contrast with conventional analog broadcasting systems, digital broadcasting systems have superior efficiency in the utilization of the frequency spectrum and therefore allow more programs to be transmitted within the same bandwidth.

In the prior art, a digital video broadcasting (DVB) receiver is often implemented in the form of a set-top box. It is inconvenient to utilize the set-top box, especially for the users of laptop computers, because the set-top box has a large volume and requires an independent electric power source. Moreover, the conventional DVB receiver can only process a single signal channel at the same time. Therefore, it cannot allow a user to watch video programs of different channels at the same time, or record a program while watching another program.

### SUMMARY OF THE INVENTION

It is therefore an objective of the claimed invention to provide digital broadcasting signal receivers capable of processing different channels of received digital broadcasting signals in parallel to solve the above-mentioned problems.

According to an exemplary embodiment of the present invention, a digital broadcasting signal receiver is disclosed comprising: an antenna module for receiving a digital broadcasting signal; a plurality of receiving modules coupled to the antenna module for processing a plurality of channels of the digital broadcasting signal from the antenna module in parallel; and a transmission interface coupled to the plurality of receiving modules for transmitting signals from the plurality of receiving modules to a corresponding host device.

According to an exemplary embodiment of the present invention, a digital video broadcasting (DVB) receiver is also disclosed comprising: an antenna module for receiving a digital video broadcasting signal; a plurality of receiving modules coupled to the antenna module for processing a plurality of channels of the digital video broadcasting signal from the antenna module in parallel; and a USB interface coupled to the plurality of receiving modules for transmitting signals from the plurality of receiving modules to a corresponding host device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a digital broadcasting signal receiver according to one embodiment of the present invention.

FIG. 2 is a simplified block diagram of the digital broadcasting signal receiver of FIG. 1 according to an exemplary embodiment of the present invention.

### DETAILED DESCRIPTION

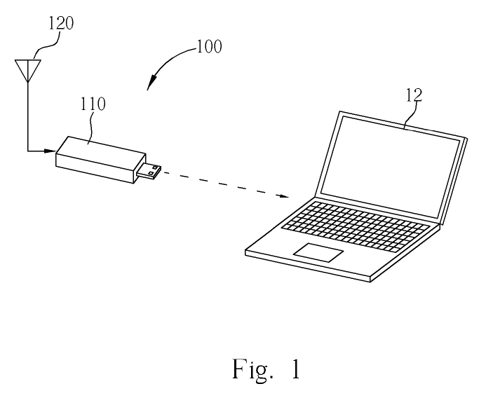

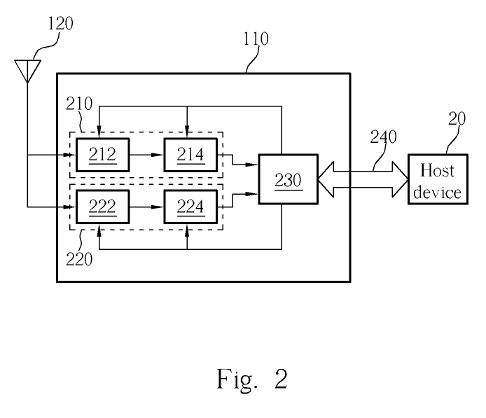

Please refer to FIG. 1, which shows a schematic diagram of a digital broadcasting signal receiver 100 according to one embodiment of the present invention. In this embodiment, the digital broadcasting signal receiver 100 is implemented in the form of a USB dongle, i.e. the digital broadcasting signal receiver 100 is able to couple to a host device 12, such as a laptop computer shown in FIG. 1, through a USB interface. As shown, the digital broadcasting signal receiver 100 comprises a housing 110 for covering and protecting inside components; and an antenna module 120 connected to the housing 110 for receiving a digital broadcasting signal. In practice, the antenna module 120 may include one or more wideband antennas, omni-directional antennas, directional antennas, or smart antennas. Preferably, the antenna module 120 is integrated inside the housing 110 to reduce the overall volume of the digital broadcasting signal receiver 100. For simplicity of explanation, in the following description the antenna module 120 is herein assumed to receive digital broadcasting signals complying with the Digital Video Broadcasting-Terrestrial (DVB-T) standard or the Digital Video Broadcasting-Handheld (DVB-H) standard. Hereinafter, implementations and operations of the digital broadcasting signal receiver 100 will be explained with reference to FIG. 2.

FIG. 2 shows a simplified block diagram of the digital broadcasting signal receiver 100 according to an exemplary embodiment of the present invention. As shown in FIG. 2, the digital broadcasting signal receiver 100 comprises a first receiving module 210, a second receiving module 220, a control unit 230, and a transmission interface 240. The first receiving module 210 comprises a first tuner 212 coupled to the antenna module 120 for down-converting the frequency of the digital broadcasting signal received by the antenna module 120; and a first demodulator 214 coupled to the first tuner 212 for demodulating signals transmitted from the first tuner 212 to generate a first video signal. Similarly, the second receiving module 220 comprises a second tuner 222 coupled to the antenna module 120 for down-converting the frequency of the digital broadcasting signal received by the antenna module 120; and a second demodulator 224 coupled to the second tuner 222 for demodulating signals transmitted from the second tuner 222 to generate a second video signal. In practice, the first tuner 212 and the second tuner 222 can be implemented with various architectures that are known in the art, such as the direct-conversion architecture or the superheterodyne architecture.

In the digital broadcasting signal receiver 100, the control unit 230 is arranged for controlling operations of the first and second receiving modules 210 and 220. For example, the control unit 230 may adjust the operating parameters of the tuners 212, 222 and the demodulators 214, 224, such as the signal frequency, bandwidth, guard interval, and so forth, according to commands from the host device 20 through the transmission interface 240. The transmission interface 240 is utilized for transmitting the first and second video signals generated from the first and second receiving modules 210 and 220 to the host device 20, such as a laptop computer, a desktop computer, a portable video player, etc. In this embodiment, the control unit 230 is a USB controller and the transmission interface 240 is a USB interface. Note that this is merely an example rather than a restriction of the practical implementations. For example, according to design requirements, the transmission interface 240 may be an IEEE 1394 interface, a PCMCIA interface, a PCI interface, a mini PCI interface, a PCI-E interface, a blue tooth transmission interface, an IEEE 802.11 series interface, or other feasible data transmission interfaces. In practice, the implementations of the control unit 230 may vary with the type of the transmission interface 240 adopted by the digital broadcasting signal receiver 100. For example, if the transmission interface 240 is replaced with a wireless transmission interface, the control unit 230 needs to be replaced with a control circuit corresponding to the wireless transmission interface instead of the above-mentioned USB controller.

In this embodiment, the digital broadcasting signal receiver 100 has two receiving modules 210 and 220 so it is capable of simultaneously processing two different channels of the received digital broadcasting signal in parallel. Accordingly, the host device 20 can simultaneously receive signals of two different channels from the digital broadcasting signal receiver 100 through the transmission interface 240, so that the user can watch video programs of two different channels at the same time or record the program of one channel while watching the program of the other channel. It can be appreciated by those of ordinary skill in the art that the number of receiving modules arranged in the digital broadcasting signal receiver 100 is not limited to two as shown in the previous embodiment. In practice, the digital broadcasting signal receiver 100 may be provided with more than two receiving modules to simultaneously process more channels of the received signal.

In addition, since the digital broadcasting signal receiver 100 is implemented in the form of a USB dongle, the required electric power may be received from the host device 20 through the transmission interface 240. Accordingly, no additional power line is required.

In the foregoing embodiments, the reception of the digital video broadcasting signal is described. This is merely for simplicity of explanation rather than a limitation of the practical applications. The disclosed architectures can also be applied in the reception of other digital broadcasting signals. For example, the disclosed architecture of the digital broadcasting signal receiver 100 is also feasible for use in the reception of the Digital Audio Broadcasting (DAB) signal. Those of ordinary skill in the art can easily realize such an application according to the disclosure of the present invention, and further details are therefore omitted for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A digital broadcasting signal receiver comprising:
an antenna module for receiving a digital broadcasting signal;
a plurality of receiving modules coupled to the antenna module for processing a plurality of channels of the digital broadcasting signal from the antenna module in parallel; and
a transmission interface coupled to the plurality of receiving modules for transmitting signals from the plurality of receiving modules to a corresponding host device.

2. The digital broadcasting signal receiver of claim 1, wherein the transmission interface is a USB interface, an IEEE 1394 interface, a PCMCIA interface, a PCI interface, a mini PCI interface, a PCI-E interface, a blue tooth transmission interface, or an IEEE 802.11 series interface.

3. The digital broadcasting signal receiver of claim 1, wherein the digital broadcasting signal complies with the Digital Video Broadcasting-Terrestrial (DVB-T) standard or the Digital Video Broadcasting-Handheld (DVB-H) standard.

4. The digital broadcasting signal receiver of claim 1, wherein the digital broadcasting signal complies with the Digital Audio Broadcasting (DAB) standard.

5. The digital broadcasting signal receiver of claim 1, wherein each of the plurality of receiving modules comprises:
a tuner coupled to the antenna module for down-converting the frequency of the digital broadcasting signal from the antenna module; and
a demodulator coupled to the tuner for demodulating signals from the tuner.

6. The digital broadcasting signal receiver of claim 5, further comprising:
a control unit coupled to the tuner and the demodulator for controlling operations of the tuner and the demodulator according to commands from the host device.

7. The digital broadcasting signal receiver of claim 1, further comprising:
a control unit coupled to the plurality of receiving modules for controlling operations of each receiving module.

8. The digital broadcasting signal receiver of claim 1, wherein the digital broadcasting signal receiver receives required electric power from the host device through the transmission interface.

9. A digital video broadcasting (DVB) receiver comprising:
an antenna module for receiving a digital video broadcasting signal;
a plurality of receiving modules coupled to the antenna module for processing a plurality of channels of the digital video broadcasting signal from the antenna module in parallel; and
a USB interface coupled to the plurality of receiving modules for transmitting signals from the plurality of receiving modules to a corresponding host device.

10. The DVB receiver of claim 9, further comprising:
a USB controller coupled to the plurality of receiving modules for controlling operations of the plurality of receiving modules according to commands from the host device.

11. The DVB receiver of claim 9, wherein the digital video broadcasting signal complies with the Digital Video Broadcasting-Terrestrial (DVB-T) standard or the Digital Video Broadcasting-Handheld (DVB-H) standard.

12. The DVB receiver of claim 9, wherein the DVB receiver receives required electric power from the host device through the USB interface.
